(19) United States
(12) Patent Application Publication
(10) Pub. No.: US 2025/0101200 A1
(43) Pub. Date: Mar. 27, 2025

(54) POLYMERIC MATERIALS WITH REDUCED ALDEHYDE CONTENT AND PROCESS

(71) Applicant: Colormatrix Holdings, Inc., Wilmington, DE (US)

(72) Inventors: Matthew JACKSON, Knowsley (GB); Christopher STARKIE, Knowsley (GB)

(21) Appl. No.: 18/730,995

(22) PCT Filed: Nov. 24, 2022
(86) PCT No.: PCT/IB2022/061397

§ 371 Date: Jul. 22, 2024

(30) Foreign Application Priority Data
Jan. 31, 2022 (GB) 2201219.9

(51) Int. Cl. C08K 5/20; C08J 3/20

(52) U.S. Cl. CPC C08K 5/20; C08J 3/201; C08J 2367/03

(57) ABSTRACT

A method of decreasing aldehyde content in a polymeric material uses a compound (Z) which includes a moiety of formula (I): wherein each R¹ and R² independently represents a substituent, n1 is 0 to 4 and n2 is 0 to 4; wherein X is selected from the group comprising C, N, P, O and S atoms; and each of the two benzene rings includes a moiety formula (A) and a moiety formula (B): NH wherein the carbon atom of moiety (A) and the nitrogen atom of moiety (B) are separated by at least one and not more than two atoms.

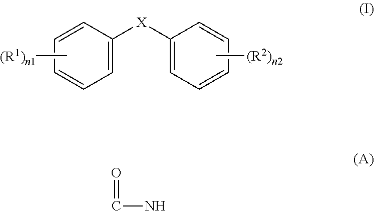

This invention relates to polymeric materials and particularly, although not exclusively, relates to polyester, for example polyethylene terephthalate, and additives therefor. Preferred embodiments relate the reduction of aldehyde in polymeric materials, especially polyester and formulations and methods relating thereto.

Polyethylene terephthalate (PET) is used on a large scale for the manufacture of food packages such as bottles. Such bottles are widely utilised for packaging of beverages, such as carbonated soft drinks, beer or mineral water. The technique commonly used to manufacture bottles from PET (ie. to convert the PET into a predetermined shape from a raw material stage) generally involves a two-stage process. In the first stage granules of the PET are injection moulded to make a preform. In the second stage the preform is blow moulded to the desired shape.

The softening point of PET is high. Thus, a typical temperature needed for processing of PET is in the region of 260° C. to 285° C. A recognised problem in the industry is that, under the high temperatures and shear conditions needed for injection moulding to make a preform and for blow moulding of the preform to make a bottle, PET tends to degrade, resulting in the formation of acetaldehyde. The presence of acetaldehyde in the material of the finished bottle is undesirable, particularly when the bottle is to be used for products for human consumption, because the acetaldehyde can migrate from the walls of the package or bottle into its contents, whereupon it adversely affects the flavour and fragrance properties of the comestible product. Whilst formation of acetaldehyde in bottles made using virgin PET is an on-going problem, acetaldehyde formation may be even higher in bottles made using recycled PET (rPET) due to the PET having multiple heat histories.

Although the migration of acetaldehyde from a PET bottle into a flavoured beverage is undesirable, a trace of acetaldehyde can often be tolerated because the taste and fragrance of the drink are not usually noticeably affected. However, the presence of even minute amounts of acetaldehyde in either a carbonated or non-carbonated drink, such as mineral water, tends to impart a most undesirable adverse taste and odour to the drink.

It is known to add acetaldehyde scavengers to PET prior to or during melt-processing to scavenge acetaldehyde which may be produced by degradation of the PET. However, there are various competing requirements associated with selection and use of acetaldehyde scavengers. For example, the weight of acetaldehyde scavenger incorporated into the PET needs to be sufficiently high to scavenge a high amount of acetaldehyde. However, higher levels of additives incorporated into PET can be detrimental to optical properties of the PET. For example, high levels of additives may detrimentally impact L* (i.e. reduce L*), a* or b*, each of which is undesirable, particularly when the PET is used for mineral water bottles where aesthetics are particularly important. Additionally, it is important for an acetaldehyde scavenger not itself to migrate significantly from the PET, since this can undesirably enter a beverage contained in a bottle made from the PET.

US20180244897 discloses methods of decreasing aldehyde content in a polymeric material. The document discloses compounds which include three moieties of general structure

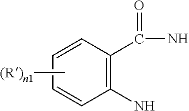

bonded to a Main Fragment. In the compounds, R′ may represent a substituent, for example, an optionally-substituted alkyl group, n1 may be 0 to 4 and the Main Fragment may be selected from a range of disclosed possibilities. Compounds described are said to exhibit lower migration, compared to migration when commercially exploited anthranilamide is used as an acetaldehyde scavenger or wherein a dimeric compound, such as that shown below, is used as an acetaldehyde scavenger

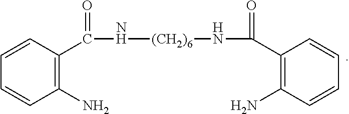

However, compounds described in US20180244897 are found to have relatively poor optical properties. For example, use of such compounds in polyester may detrimentally impact a* and b* of the polyester and, consequently, any bottles made therefrom.

It is an object of the present invention to address the above-described problems.

According to a first aspect of the invention, there is provided a method of decreasing aldehyde content in a polymeric material, the method comprising the step of contacting the polymeric material with a compound (Z) which includes a moiety of formula:

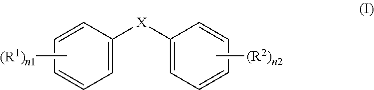

wherein each R¹ and R² independently represents a substituent, n1 is 0 to 4 and n2 is 0 to 4;
wherein X represents a moiety which includes an atom bonded directly to the two benzene rings, wherein said atom is selected from the group comprising C, N, P, O and S atoms;
wherein the left hand benzene ring (herein referred to as the “LHBR”) in the moiety of formula (I) includes a moiety

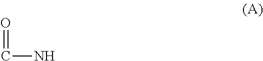

and a moiety
   NH (B)
wherein the carbon atom of moiety (A) and the nitrogen atom of moiety (B) are separated by at least one and not more than two atoms;
   wherein the right hand benzene ring (herein referred to as the “RHBR”) in the moiety of formula (I) includes a moiety

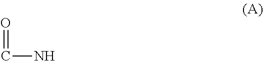

and a moiety
   NH (B)
wherein the carbon atom of moiety (A) and the nitrogen atom of moiety (B) are separated by at least one and not more than two atoms.

It has been found that compounds (Z) exhibit an advantageous compromise in providing high levels of aldehyde scavenging at acceptable additional rates in said polymeric material, for example in polyester, whilst not significantly impacting optical properties (e.g. L*, a* and/or b*), and exhibit a relatively low level of migration from the polymer.

In said LHBR, the carbon atom of moiety (A) and the nitrogen atom of moiety (B) may be separated by at least one and not more than two carbon atoms. The or both of said carbon atoms which separate moieties (A) and (B) is preferably unsaturated. The carbon atom of moiety (A) and the nitrogen atom of moiety (B) are preferably separated by two atoms which are preferably carbon atoms and are preferably both unsaturated carbon atoms. The carbon atom of moiety (A) and the nitrogen atom of moiety (B) are preferably directly bonded to said LHBR.

The moiety (B) is preferably bonded to a carbon atom of the LHBR which is ortho to the carbon atom to which the moiety (A) is bonded.

In said LHBR, said moiety (A) may be bonded meta or para to the carbon atom to which moiety X is bonded. Preferably, moiety (B) is not bonded ortho to the carbon atom to which moiety X is bonded. In a preferred embodiment, said moiety (A) is bonded meta to the carbon atom to which moiety X is bonded and moiety (B) is bonded para to the carbon atom to which moiety X is bonded.

Said LHBR may be a part of a moiety:

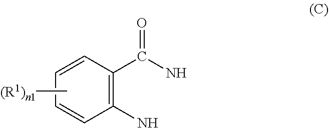

wherein R¹ represents a substituent and n1 is 0 to 4, for example 0 to 1. R¹ may be an optionally-substituted, for example unsubstituted, alkyl group, for example an optionally-substituted, for example unsubstituted, C₁₋₂₀, for example C₁₋₁₀, alkyl group. R¹ may be arranged to improve the compatibility of compound (Z) in the polymeric material with which it is contacted in the method, for example by virtue of R¹ including relevant functional groups to improve compatibility. Alternatively and/or additionally, R¹ may be arranged to increase the mass of the compound (Z).

Preferably, in said LHBR, n1 is 0.

Moiety (B) is preferably NH₂ and/or the NH moiety bonded to the LHBR is preferably NH₂.

Preferably, in structure (C), the amide moiety is bonded meta or para, preferably meta, to the carbon atom of the benzene ring of moiety (C) to which moiety X is bonded.

The moiety (C) is suitably capable of reacting with aldehyde in a condensation reaction to produce a moiety

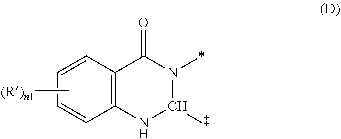

wherein the bond with a * and the bond with a * represent part of the aldehyde which reacts with moiety (C).

When the level of aldehyde is reduced in the method, compound (D) may be of formula

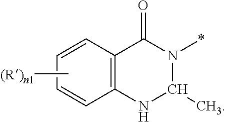

Thus, by virtue of the reaction, the aldehyde (e.g. acetaldehyde) is scavenged and its residue becomes covalently bonded into the compound (I).

In said RHBR, the carbon atom of moiety (A) and the nitrogen atom of moiety (B) may be separated by at least one and not more than two carbon atoms. The or both of said carbon atoms which separate moieties (A) and (B) is preferably unsaturated. The carbon atom of moiety (A) and the nitrogen atom of moiety (B) are preferably separated by two atoms which are preferably carbon atoms and are preferably both unsaturated carbon atoms. The carbon atom of moiety (A) and the nitrogen atom of moiety (B) are preferably directly bonded to said RHBR. The moiety (B) is preferably bonded to a carbon atom of the RHBR which is ortho to the carbon atom to which the moiety (A) is bonded.

In said RHBR, said moiety (A) may be bonded meta or para to the carbon atom to which moiety X is bonded. Preferably, moiety (B) is not bonded ortho to the carbon atom to which moiety X is bonded. In a preferred embodiment, said moiety (A) is bonded meta to the carbon atom to which moiety X is bonded and moiety (B) is bonded para to the carbon atom to which moiety X is bonded.

Said RHBR may be a part of a moiety:

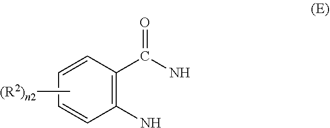

wherein R² represents a substituent and n2 is 0 to 4, for example 0 to 1. R² may be an optionally-substituted, for example unsubstituted, alkyl group, for example an optionally-substituted, for example unsubstituted, C₁₋₂₀, for example C₁₋₁₀, alkyl group. R² may be arranged to improve the compatibility of compound (Z) in the polymeric material with which it is contacted in the method, for example by virtue of R² including relevant functional groups to improve compatibility. Alternatively and/or additionally, R² may be arranged to increase the mass of the compound (Z).

Preferably, in said RHBR, n2 is 0.

Moiety (B) is preferably NH₂ and/or the NH moiety bonded to the RHBR is preferably NH₂.

Preferably, in structure (E) of the RHBR, the amide moiety is bonded meta or para, preferably meta, to the carbon atom of the benzene ring of moiety (E) to which moiety X is bonded.

Said LHBR and said RHBR are preferably substituted with the same atoms or groups. Said LHBR and said RHBR are preferably each substituted with a primary amine moiety (i.e. NH₂). Preferably, a nitrogen atom of a first group NH₂ is directly bonded to the LHBR and a nitrogen atom of a second group NH₂ is directly bonded to the RHBR. Said LHBR and said RHBR are preferably each substituted with a primary amide moiety (i.e —CONH₂).

Preferably, a carbonyl carbon atom of a first group —CONH₂ is directly bonded to the LHBR and a carbonyl carbon atom of a second group —CONH₂ is directly bonded to the RHBR. In a preferred embodiment, in both the RHBR and the LHBR, the carbonyl carbon atoms of the respective —CONH₂ groups is bonded meta to the carbon atoms of the respective benzene rings to which moiety X is bonded and the nitrogen atom of the NH₂ groups is bonded para to the carbon atoms of the respective benzene rings to which moiety X is bonded.

Said RHBR and said LHBR are preferably identical and/or are systematically arrange on opposite sides of moiety X.

Said RHBR preferably include only one primary amide group and only one primary amine group; and preferably n1 is 0.

Said LHBR preferably includes only one primary amide group and only one primary amine group; and preferably n2 is 0.

Said compound (Z) is preferably not a polymer and preferably does not include any polymeric moiety.

Said compound (Z) may be a solid or a liquid at 25° C. Said compound (Z) is preferably a solid at 25° C. Said compound (Z) may have a melting point, measure by DSC, of at least 50° C., preferably at least 100° C.

Preferably, X represents a moiety which includes a carbon or oxygen atom bonded directly to the LHBR and the RHBR. More preferably, X represents a moiety which includes a carbon atom bonded directly to the LHBR and the RHBR.

When X represents a moiety which includes a carbon atom bonded directly to the LHBR and the RHBR, moiety X preferably comprises a carbon atom of a carbonyl moiety or of a moiety CR³R⁴ bonded directly to the LHBR and the RHBR, wherein R³ and R⁴ independently represent a hydrogen atom, an optionally-substituted, preferably unsubstituted, alkyl (eg a C₁₋₂₀ or C₁₋₁₀ alkyl), cycloalkyl, phenyl or naphthyl group. R³ and R⁴ may be arranged to improve the compatibility of compound in the polymeric material with which it is contacted in the method, for example by virtue of R³ and R⁴ including relevant functional groups to improve compatibility. Alternatively, and/or additionally, R³ and R⁴ may be arranged to increase the mass of the compound (Z).

Preferably, at least one of R³ and R⁴ is a hydrogen atom.

Preferably, moiety X includes only carbon and hydrogen atoms and no other types of atoms.

Preferably, moiety X comprises a carbon atom of a moiety CR³R⁴ (i.e C in the moiety CR³R⁴) bonded directly to the LHBR and the RHBR, wherein R³ represents a hydrogen atom and R⁴ is selected from the group comprising a hydrogen atom and an unsubstituted phenyl or napththyl group. In a preferred embodiment, both R³ and R³ are hydrogen atoms.

Said moiety X may have a molecular weight of less than 300 daltons, preferably less than 200 daltons, more preferably less than 150 daltons. The molecular weight may be at least 14 daltons. Said moiety X may have a molecular weight in the range 14 to 140 daltons.

In a preferred embodiment, in said moiety of formula (I), n1 and n2 are 0. In a preferred embodiment, said moiety of formula (I) has the structure:

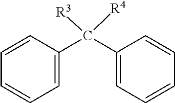

wherein the RHBR includes one primary amide group and one primary amine group, wherein the carbon atom of the amide group and the nitrogen atom of the amine group are separated by two atoms;
wherein the LHBR includes one primary amide group and one primary amine group, wherein the carbon atom of the amide group and the nitrogen atom of the amine group are separated by two atoms;
   wherein R³ represents a hydrogen atom;
   wherein R⁴ represents a hydrogen atom, an unsubstituted phenyl group or an unsubstituted napththyl group.
   In an especially preferred embodiment, said compound (Z) is of formula

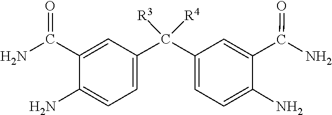

wherein R³ represents a hydrogen atom; and
wherein R⁴ represents a hydrogen atom, an unsubstituted phenyl group or an unsubstituted napththyl group.
R⁴ preferably represents a hydrogen atom.

The polymeric material contacted in the method may be any polymeric material which may incorporate an aldehyde in need of being scavenged or otherwise decreased. It may comprise a polyester (especially a poly(ethylene terephthalate)), a polyurethane or a polyolefin. Preferably, it comprises a polyester, (especially a poly(ethylene terephthalate)).

A reference herein to “ppm” refers to “parts per million” by weight.

Methods for measurement of acetaldehyde in industrially injection-moulded polyethylene terephthalate preforms have been described by FI Villian et al., Journal of Polymer Science, Vol. 52, 55-60 (1994).

Said contacting step may be carried out with the polymeric material in a molten state. Alternatively, said compound (Z) may be added to solid polymeric material, suitably at a temperature below the melting point of the polymeric material so the polymeric material is not in a fluid and/or molten state. In one, less preferred, embodiment, compound (Z) may be added to monomers, oligomers or pre-polymers involved in the preparation of said polymeric material.

Prior to said contacting step, said polymeric material is preferably selected, suitably when in a solid state as aforesaid. Said selected polymeric material is suitably present substantially in the absence of monomers used in preparation of the polymeric material. Said selected polymeric material is preferably in a state in which it is isolated from a reaction mixture in which it may have been formed. It is preferably an isolated polymeric material. The method may include the step of drying the polymeric material prior to said contacting step. Said selected polymeric material is preferably in a particulate form, for example in the form of pellets or granules.

In a preferred embodiment the total ppm (based on the weight of said polymeric material) of compound (Z) contacted with said polymeric material is suitably at least 100 ppm, preferably 200 ppm, more preferably at least 450 ppm. It may be less than 2000 ppm or less than 1000 ppm.

Said compound (Z) may be associated with, for example mixed with, an organic liquid carrier, which is compatible with said polymeric material. Typical carriers include hydrocarbons, hydrocarbon mixtures, alcohols, esters, polyethers and mixtures of two or more thereof.

A polymeric material-compatible organic liquid carrier (especially wherein said polymeric material is a polyester) may be an oil-based vehicle. Examples of such vehicles are the materials sold as Clearslip™ 2, Clearslip™ 3 & Process Aid-1 by ColorMatrix Europe Ltd, of Units 9-11 Unity Grove, Knowsley Business Park, Merseyside, L34 9GT.

The wt % of compound (Z) in said mixture may be less than 60% wt %, preferably less than 50 wt %. The wt % may be in the range 10-50 wt %.

In a preferred embodiment, the method comprises contacting the polymeric material with a formulation according to the third aspect.

When said polymeric material is a polyester, as is preferred, said polyester is preferably a polyethylene terephthalate which term, in the context of the present specification, is intended to encompass co-polyethylene terephthalates. Co-polyethylene terephthalates of polyethylene terephthalate may contain repeat units from at least 85 mole % terephthalic acid and at least 85 mole % of ethylene glycol. Dicarboxylic acids which can be included, along with terephthalic acid, are exemplified by phthalic acid, isophthalic acid, naphthalene-2,6-dicarboxylic acid, cyclohexanedicarboxylic acid, cyclohexanediacetic acid, diphenyl-4,4′-dicarboxylic acid, succinic acid, glutaric acid, adipic acid, azelaic acid and sebacic acid. Other diols which may be incorporated in the co-polyethylene terephthalates, in addition to ethylene glycol, include diethylene glycol, triethylene glycol, 1,4-cyclohexanedimethanol, propane-1,3-diol, butane-1,4-diol, pentane-1,5-diol, hexane-1,6-diol, 3-methylpentane-2,4-diol, 2-methyl pentane-1,4-diol, 2,2,4-trimethylpentane-1,3-diol, 2-ethylhexane-1,3-diol, 2,2-diethylpropane-1,3-diol, hexane-1,3-diol, 1,4-di(hydroxyethoxy)-benzene, 2,2-bis-(4-hydroxycyclohexyl)-propane, 2,4-dihydroxy-1,1,3,3-tetramethyl-cyclobutane, 2,2-bis-(3-hydroxyethoxyphenyl)-propane, and 2,2-bis-(4-hydroxypropoxyphenyl)-propane. In a preferred embodiment said polyethylene terephthalate has less than 10 mole %, more preferably less than 6 mole % especially less than 2 mole % comonomer substitution. Preferably, said co-polyethylene terephthalate does not comprise co-polyethylene terephthalate; it suitably comprises substantially a homopolymer produced by esterification or transesterification of terephthalic acid or dimethyl terephthalate and ethylene glycol to produce bis(2-hydroxyethyl) terephthalate which is then subjected to polycondensation at high temperatures in vacuum in the presence of a catalyst.

As used herein the term “IV” refers to the Inherent Viscosity of the polymeric material. It may be determined on a solution of 0.5 g of polymer dissolved in 100 ml of a mixture of phenol (60% by volume) and tetrachloroethane (40% by volume).

When said polymeric material is a polyester, the IV of the polyester at the time of contact with said compound (Z) is preferably greater than 0.5 dL/g, more preferably greater than 0.65 dL/g.

When said polymeric material is a polyester, the polyester may be specifically adapted for use in extrusion blow moulding (EBM). Such adaptations are known to those skilled in the art and include increasing the amount of co-monomers, altering IV and structure.

Said polymeric material is preferably a part of and/or defines an article, for example, a shaped article. Said article may be selected from a preform, a container, a bottle, a cup, a tray, a thermoformed sheet, or other desirable shape.

After contact of said polymeric material with compound (Z), said polymeric material may include 50-1000 ppm of compound (Z), preferably 100 to 700 ppm or 150 to 600 ppm of compound (Z) based on the amount of said polymeric material, for example polyester.

The invention extends to a method of making an article, for example a shaped article, from a polymeric material, the method comprising
(a) selecting a compound (Z) as described;
(b) contacting the polymeric material with said compound (Z); and
(c) forming said polymeric material into an article, for example a shaped article.

Preferably, step (b) is carried out with the polymeric material not in a fluid, for example molten, state. Thereafter, in step (c), the polymeric material is suitably melt-processed to define said article.

Said article may be defined by any process known in the art. For example, said process may comprise injection molding, blow molding or thermoforming. For example, injection molding may be used to form preforms used to blow bottles, food/beverage containers, trays or other desirable shapes. Also, said process may comprise production of a sheet which may subsequently be thermoformed to define an article, for example a receptacle such as a cup or tray. Alternatively, molten polymeric material may be used in extrusion blow molding operations to provide bottles, food containers and the like. Molten polymeric material melt may similarly be fed to an extruder to produce films, sheet, profiles, pipe and the like.

Preferably, said article comprises a container or preform for a container, preferably made from a polyester as described. More preferably, said shaped article comprises a preform, for example for a bottle, such as a beverage bottle.

Said article may include one or more colourants, for example, at least one blue colourant. After contact of said polymeric material with compound (Z), said polymeric material may include 1-1000 ppm of a colourant (eg a blue colourant) and, preferably, includes 5-500 ppm of a colourant (eg a blue colourant), the aforementioned ppm being based on the amount of said polymeric material, for example polyester. A said colourant described herein may be a dye or pigment.

Said article may include one or more reheat additives, for example titanium nitride or tungsten oxide (especially the latter) as described in WO2016/063013, the content of which is incorporated herein by reference insofar as it relates to titanium nitride and tungsten oxide. After contact of said polymeric material with compound (Z), said polymeric material may include 1-1000 ppm of a reheat additives (eg titanium nitride or tungsten oxide), and, preferably, includes 5-500 ppm of a reheat additives (eg titanium nitride or tungsten oxide), the aforementioned ppm being based on the amount of said polymeric material, for example polyester.

Preferably, in said shaped article, the sum of the wt % of polymeric material(s), for example the amount of polyester, and the amounts of compound (Z) is at least 90 wt % or at least 95 wt % or at least 98 wt %.

According to a second aspect of the invention, there is provided a polymeric material, for example polyester, having a reduced level of aldehyde, for example acetaldehyde, said polymeric material, for example polyester, incorporating a compound (Z) according to the first aspect or a product of a reaction between compound (Z) and aldehyde, for example acetaldehyde.

A product of a reaction between compound (Z) and aldehyde, for example acetaldehyde, suitably includes a fragment derived from the first fragment as follows:

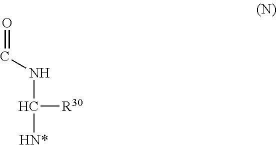

wherein the carbon atom of the carbonyl moiety and the starred (*) nitrogen atom are separated by at least one and not more than two atoms as described for said first fragment and R³⁰ refers to a residue of the aldehyde and is suitably a methyl group when said aldehyde is acetaldehyde.

A product of said reaction preferably includes a moiety

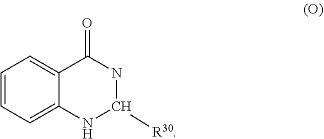

The nitrogen atom adjacent the carbonyl group is suitably bonded to a main fragment as described according to the first aspect.

Said polymeric material of the second aspect is preferably a part of and/or defines an article, for example, a shaped article which may be selected from a preform, a container, a bottle, a cup, a tray or a thermoformed sheet. Thus, the invention extends to an article or part thereof of the type described, wherein said article or part thereof includes a polymeric material which incorporates a compound (Z), a fragment (N) or a product of a said reaction which includes a moiety (O). Said article may include at least 90 wt %, for example at least 95 wt % polyester as described. Said article may include 50-1000 ppm of compound (Z), preferably 100 to 700 ppm or 150 to 600 ppm of compound (Z) based on the amount of said polymeric material, for example polyester, in said article. Said article may include one or more colourants, for example, at least one blue colourant. Said article may include 1-1000 ppm of a colourant (eg a blue colourant) and, preferably, includes 5-500 ppm of a colourant (eg a blue colourant), the aforementioned ppm being based on the amount of said polymeric material, for example polyester.

Said article may include one or more reheat additives, for example titanium nitride or tungsten oxide (especially the latter) as described herein. Said polymeric material may include 1-1000 ppm of a reheat additives (eg titanium nitride or tungsten oxide), and, preferably, includes 5-500 ppm of a reheat additives (eg titanium nitride or tungsten oxide), the aforementioned ppm being based on the amount of said polymeric material, for example polyester.

Preferably, in said shaped article, the sum of the wt % of polymeric material(s), for example the amount of polyester, and the amounts of compound (Z) is at least 90 wt % or at least 95 wt % or at least 98 wt %.

In a preferred embodiment, said polymeric material of the second aspect is part of a preform or bottle, wherein a wall of the preform or bottle comprises said polymeric material and the product which includes fragment (N) and/or moiety (0). Thus, the invention extends to a preform or bottle (e.g. beverage bottle) which includes a wall defined by a polyester, wherein the polyester incorporates a compound (Z) and/or fragment (N) and/or moiety (0).

In a third aspect of the invention, there is provided a formulation comprising a compound (Z) according to the first aspect in combination with a carrier.

Said formulation may include at least 50 wt % of said carrier, preferably at least 60 wt %, more preferably at least 70 wt %, especially at least 75 wt %. Said formulation may include less than 80 wt % of said carrier.

Said formulation may include 50-90 wt % of a carrier, 10-50 wt % of said compound (Z) and 0-30 wt % of other additives. Said other additives may be selected from colourants, antioxidants, thickeners, process stabilizers, UV additives and reheat additives. In one preferred embodiment, said formulation includes 0.5 to 10 wt % of one or more colourants, for example, at least one blue colourant. In another embodiment, said formulation includes 0.5 to 10 wt % of one or more reheat additives, for example titanium nitride or tungsten oxide (especially the latter) as described in WO2016/063013, the content of which is incorporated herein by reference insofar as it relates to titanium nitride and tungsten oxide. In a preferred embodiment, said formulation includes at least some colourant, for example a blue colourant.

A said colourant described herein may be a dye or pigment.

Preferably, in said formulation, the sum of the wt % of carrier(s) and compound (Z) is at least 80 wt % or at least 90 wt %.

Said formulation may be a solid masterbatch or a liquid formulation. When it is a solid masterbatch, it may comprise 60-90 wt % of a thermoplastic polymer, for example a polyester, especially when said formulation is for use with a polyester. It may include 10-40 wt % of compound (Z) and 60-90 wt % of thermoplastic polymer.

A solid masterbatch may include 0 to 10 wt %, preferably 0.5 to 10 wt %, of one or more colourants.

When said formulation is a liquid formulation, said formulation may comprise 50 to 80 wt % of a liquid carrier and 20 to 50 wt % of compound (Z). Said liquid carrier may be a liquid at 25° C. and atmospheric pressure. It may comprise an oil (e.g. vegetable or mineral oil) or a glycol. A liquid formulation may include 0 to 10 wt %, preferably 0.5 to 10 wt % of one or more colourants.

In a fourth aspect, there is provided an assembly comprising a melt processing apparatus, for example an injection moulding machine or an extruder, in combination with a receptacle which contains the formulation of the third aspect, wherein said formulation is arranged to be introduced into polymeric material which is melt processed in the melt processing apparatus, The assembly may include means, for example a pump and/or injector for contacting formulation with a polymeric material, for example a polyester, arranged to be melt processed in the melt processing apparatus. Formulation may be contacted with pellets of polymeric material; or, preferably, formulation in a liquid state, may be added to molten polymer. The pellets or molten polymer may, after contact, be melt processed to define desired products.

Any feature of any aspect of any invention or embodiment described herein may be combined with any feature of any other aspect of any invention or embodiment described herein mutatis mutandis.

Specific embodiments of the invention will now be described by way of example

The following material is referred to hereinafter:
C93 PET—refers to a widely used bottle grade PET from Equipolymers.

In general terms, an acetaldehyde scavenger is contacted and mixed with polyester, especially PET, and the combination (together with any other additives) is injection moulded to produce a container preform. Preforms are well known. They suitably have a test-tube like body and a threaded neck adjacent an open end, there being a capping flange associated with the neck. Preforms are arranged to be blow moulded to form a container, for example a beverage container that may be closed by a cap which releasably engages a threaded neck.

Acetaldeyde scavengers described may be solids or liquids. When they are solids, they may be provided as dispersions in a carrier, for example a mineral oil or other carrier which is compatible with the polyester into which the scavenger is to be mixed. When they are liquids, the liquid may be used directly or could be diluted by a carrier as aforesaid. In some embodiment, a carrier for an acetaldehyde scavenger may be solid at 25° C.

Examples 1 to 4 hereinafter describe the preparation of preferred scavenger compounds and subsequent examples describe the testing and analysis of such compounds.

### EXAMPLE 1—PREPARATION OF 5,5′-METHYLENEBIS(2-AMINOBENZAMIDE) (1.4 IN SCHEME below)

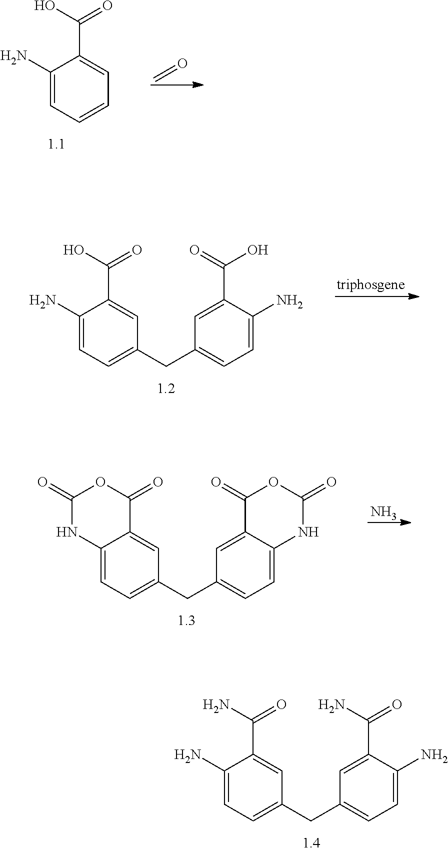

Step 1 Preparation of 5,5′-methylenebis(2-aminobenzoic acid) (1.2)

A 2 L round bottom flask was charged with de-mineralized H₂O (500 mL) and anthranilic acid (50.00 g, 1 Eq). The resulting suspension was treated with a 3% aqueous solution of formaldehyde (0.15 L, 0.4 eq). The reaction mixture was stirred for 90 minutes and the consistency of the solids changed. Then HCl 37% (400 mL 13 eq) was added drop-wise and, over 50 minutes, the temperature rose from 23.8° C. to a maximum of 35° C. After 250 mL had been added, suspension turned yellow; after 350 mL had been added, there was a clear yellow solution. After all was added, the reaction mixture was heated overnight (internal 55° C.). A white suspension formed. 10% of the starting material was present but there was no trace of any trimer compound. The reaction mixture was continued to be heated for 6 hours and then put into an ice bath to cool to 20° C. The pH was adjusted to pH=3.5 by slowly adding NaOH 30% without exceeding T=25° C. and the reaction mixture was stirred overnight. The suspension was filtered and the resulting cake was washed with H₂O (4*200 mL) followed by acetonitrile wash (2*200 mL). The material was collected and dried under vacuum at 60° C. ¹H-NMR and HPLC-MS confirmed the target compound had been produced.

Step 2 Preparation of 6,6′-methylenebis(2H-benzo[d][1,3]oxazine-2,4(1H)-dione) (1.3)

A suspension of 5,5′-methylenebis(2-aminobenzoic acid) (1.2)(27.30 g, 1 Eq, 95.36 mmol) in 1,4-dioxane (500 mL) was heated to ˜75° C. until almost all dissolved. The suspension was cooled to 55° C. and to it with intense stirring was slowly added a solution of triphosgene (18.68 g, 0.66 Eq, 62.94 mmol) in 1,4-dioxane (200 mL). A small exotherm was observed (to 57° C.). The reaction mixture immediately forms solids and forms yellow suspension that was difficult to stir. 300 mL of 1,4-dioxane was added using an overhead stirring. Ion-pair chromatography (IPC) showed there was full conversion to the target compound. Next, to the reaction mixture was added 800 mL of water which turned the suspension white. The reaction mixture was centrifuged, the supernatant removed and the solids suspended in water and centrifuged again. This was repeated once more. The solids were suspended in acetone and centrifuged twice. The solids were collected and dried to yield: 6,6′-methylenebis(2H-benzo[d][1,3]oxazine-2,4(1H)-dione) (18.20 g, 56.42%).

Step 3 Preparation of 5,5′-methylenebis(2-aminobenzamide) (Compound 1.4)

In a 500 mL, 3-neck, round bottom flask was suspended 6,6′-methylenebis(2H-benzo[d][1,3]oxazine-2,4(1H)-dione) (18.20 g, 1 Eq, 53.80 mmol) in DMSO (100 mL) and NMP (50 mL) was added. The reaction mixture was cooled to −5° C. and to it was slowly added 25% ammonia solution in H₂O (29.32 g, 32 mL, 8 Eq, 430.4 mmol) diluted in 150 mL of DMSO, whilst keeping the temperature at <−2° C. Ion-pair chromatography (IPC) showed there was full conversion to the target compound. Then, to the reaction mixture was added 300 mL of hot water (˜60° C.) and the reaction mixture was stirred until solids formed. The solids were collected by filtration and washed with water and acetone to yield: 5,5′-methylenebis(2-aminobenzamide) (12.00 g, 78.45%). The melting point was 292.7° C.

### EXAMPLE 2—PREPARATION OF 5,5′-(PHENYLMETHYLENE)BIS(2-AMINOBENZAMIDE) (2.5 IN THE SCHEME BELOW)

The preparation involves the following steps for preparation of the target compound:

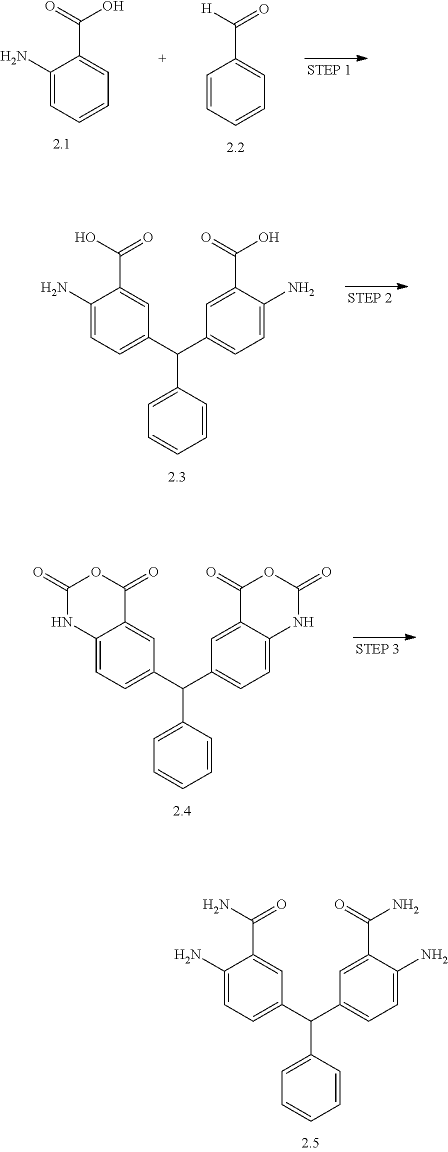 [SMILES: Nc1ccccc1C(=O)O ; O=Cc1ccccc1 ; Nc1ccc(C(c2ccccc2)c2ccc(N)c(C(=O)O)c2)cc1C(=O)O ; O=c1[nH]c2ccc(C(c3ccccc3)c3ccc4[nH]c(=O)oc(=O)c4c3)cc2c(=O)o1 ; NC(=O)c1cc(C(c2ccccc2)c2ccc(N)c(C(N)=O)c2)ccc1N]

Step 1 Preparation of 5,5′-(Phenylmethylene)bis(2-aminobenzoic acid) (2.3).

2-Aminobenzoic acid (25.0 g, 2 Eq, 182 mmol) and benzaldehyde (9.67 g, 1 Eq, 91.1 mmol) were added to a stirred mixture of water (155 mL) and concentrated hydrochloric acid (216 g, 145 mL, 37% wt, 24 Eq, 2.19 mol). The mixture was heated at 70° C. over a weekend. The mixture was cooled in ice and basified by addition of concentrated NaOH (around 150 mL). After the intense purple colour had disappeared the solution was still acidic. The solids were isolated by suction filtration, washed with water (3 times), transferred with acetonitrile into a 500 mL round bottom flask and dried under reduced pressure (rotavap) at 50 0° C. Yield: 25.15 g, 76%. The identity of the product was confirmed by HPLC-MS and ¹H-NMR.

Step 2 Preparation of 6,6′-(Phenylmethylene)bis(2H-benzo[d][1,3]oxazine-2,4(1H)-dione) (2.4).

Under nitrogen atmosphere a solution of triphosgene (6.14 g, 0.75 Eq, 20.7 mmol) in 1,4-dioxane (20 mL) was added to a stirred suspension of 5,5′-(phenylmethylene)bis(2-aminobenzoic acid) (2.3, 10.0 g, 1 Eq, 27.6 mmol) in 1,4-dioxane (200 mL). The mixture was heated at 55° C. for 3 hours. The clear solution was concentrated under reduced pressure at 50° C. TBME was added to the residue. The pink powder was isolated by suction filtration and dried under reduced pressure at 50° C. Yield: 12.78 g, 112%. The product was used as such in the next step.

Step 3 Preparation of 5,5′-(Phenylmethylene)bis(2-aminobenzamide) (2.5)

At 0° C. ammonia (18.8 g, 20 mL, 25% wt, 10 Eq, 276 mmol) was added slowly to a stirred solution of 6,6′-(phenylmethylene)bis(2H-benzo[d][1,3]oxazine-2,4(1H)-dione) (11.4 g, 1 Eq, 27.6 mmol) in DMF (100 mL). The ice-water bath was removed and stirring was continued at room temperature for 45 minutes. The reaction mixture was concentrated under reduced pressure. The residue was dissolved in MeOH, put on Hydromatrix™ and purified by automated column chromatography (220 g of silica, 0-10% MeOH in DCM). Fractions containing the product were combined and concentrated under reduced pressure to yield a white solid (5.20 g). As NMR showed some small impurities the product was purified again by column chromatography. Hydromatrix (10 g) and methanol were added to the isolated material. The mixture was concentrated under reduced pressure and purified by automated column chromatography (120 g of silica, 0-10% MeOH in DCM). Fractions containing the product were combined and concentrated under reduced pressure to yield the desired product. Yield: 3.08 g, 31%. Purity by HPLC: 99.2% at 215 nm. The product melted between 100-150° C.

### EXAMPLE 3—PREPARATION OF 5,5′-(NAPHTHALEN-2-YLMETHYLENE)BIS(2-AMINOBENZAMIDE) (3.5 IN THE SCHEME BELOW)

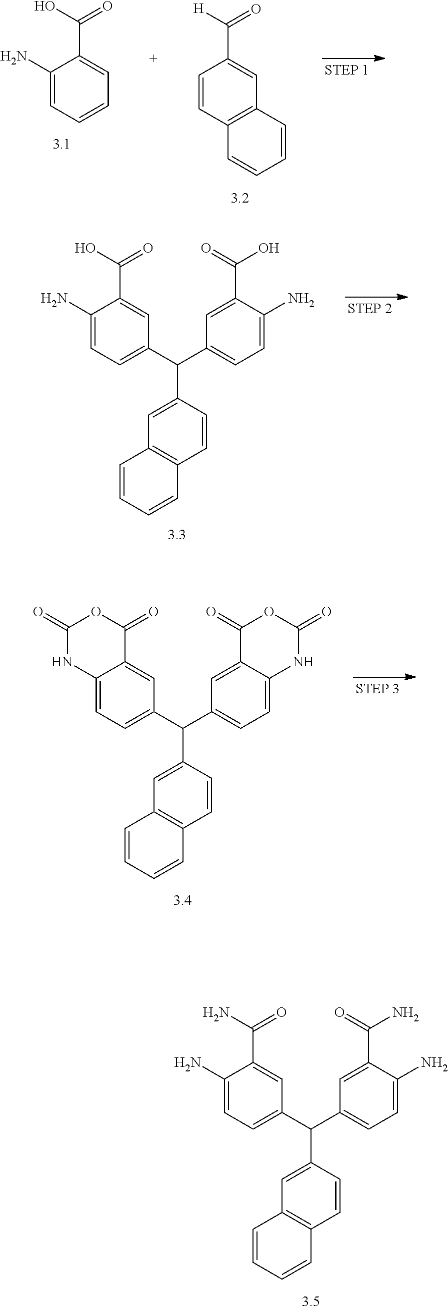 [SMILES: Nc1ccccc1C(=O)O ; O=Cc1ccc2ccccc2c1 ; Nc1ccc(C(c2ccc(N)c(C(=O)O)c2)c2ccc3ccccc3c2)cc1C(=O)O ; O=c1[nH]c2ccc(C(c3ccc4ccccc4c3)c3ccc4[nH]c(=O)oc(=O)c4c3)cc2c(=O)o1 ; NC(=O)c1cc(C(c2ccc(N)c(C(N)=O)c2)c2ccc3ccccc3c2)ccc1N]

The preparation involves the following steps for preparation of the target compound:

Step 1 Preparation of 5,5′-(Naphthalen-2-ylmethylene)bis(2-aminobenzoic acid) (3.3)

Concentrated hydrochloric acid (216 g, 145 mL, 37% wt, 24 Eq, 2.19 mol) was added to a stirred suspension of 2-aminobenzoic acid (25.0 g, 2 Eq, 182 mmol) and 2-naphthaldehyde (14.2 g, 1 Eq, 91.1 mmol) in water (155 mL). The mixture was heated at 70° C. overnight. The solids slowly went into solution; however, it seemed as if 2-naphthaldehyde had sublimated out of the solution and so solids were washed down with a few millilitres of dioxane and heating was continued for another 24 hours. The reaction mixture was cooled to room temperature. The solution was decanted. The remaining solids were heated with water (50 mL) and combined with the previous solution. The aqueous solution was neutralised with concentrated NaOH (aq.). The slightly green solids were isolated by suction filtration, washed with water, co-evaporated under reduced pressure with acetonitrile and dried further under reduced pressure at 50 0° C. Crude yield: 17 g. The crude product was purified by automated column chromatography (220 g of silica gel, 0-5% MeOH in DCM). Fractions containing the product were combined and concentrated under reduced pressure at 50° C. to yield a foam. Yield: 6.08 g, 16%. ¹H-NMR and HPLC (MeOH) showed the desired product at Rt=0.50 min with M+1=413 and M−1=411.

Step 2 Preparation of 6,6′-(Naphthalen-2-ylmethylene)bis(2H-benzo[d][1,3]oxazine-2,4(1H)-dione) (3.4)

Triphosgene (3.26 g, 0.75 Eq, 11.0 mmol) was added to a stirred solution of 5,5′-(naphthalen-2-ylmethylene)bis(2-aminobenzoic acid) (6.05 g, 1 Eq, 14.7 mmol) in 1,4-dioxane (70 mL). The mixture was heated at 55° C. Almost immediately a solid was formed. After a while a clear solution was obtained. After heating for 2 hours the reaction mixture was concentrated under reduced pressure. Yield: 10.22 g. The crude product was used immediately in the next step. HPLC (MeCN) showed product at 0.86 min with M−1=463.

Step 3 Preparation of 5,5′-(Naphthalen-2-ylmethylene)bis(2-aminobenzamide) (3.5)

The crude material from Step 2 (max 14.7 mmol) was used as starting material. At 0° C. ammonia (10.0 g, 11 mL, 25% wt, 10 Eq, 147 mmol) was added slowly to a stirred solution of the 6,6′-(naphthalen-2-ylmethylene)bis(2H-benzo[d][1,3]oxazine-2,4(1H)-dione) (6.83 g, 1 Eq, 14.7 mmol) in DMF (50 mL). After 5 minutes the ice-water bath was removed and stirring was continued at room temperature. HPLC (DMSO) showed a mixture of the desired product (74%) at Rt=0.95 (M−1=409) and urea (20%) at 0.68 min (M−1=453).

After 45 minutes the reaction mixture was concentrated under reduced pressure, the crude material was dissolved in MeOH, put on Hydromatrix™ and purified by automated column chromatography (120 g of silica, 0-20% MeOH in DCM). Fractions containing the product were combined and concentrated under reduced pressure to give a foam. The compound was heated with EtOH. Water was added dropwise until the product started to crystallise. After standing overnight at room temperature the slightly blue solids were isolated by suction filtration, washed with EtOH and dried under reduced pressure at 50 0° C. Yield: 3.15 g, 52%. Purity by HPLC: 98.4% at 215 nm. The melting point was 200.3° C.

### EXAMPLE 4 PREPARATION OF 5,5′-OXYBIS(2-AMINOBENZAMIDE) (4.6)

The synthesis of compound 4.6 is depicted in the scheme below.

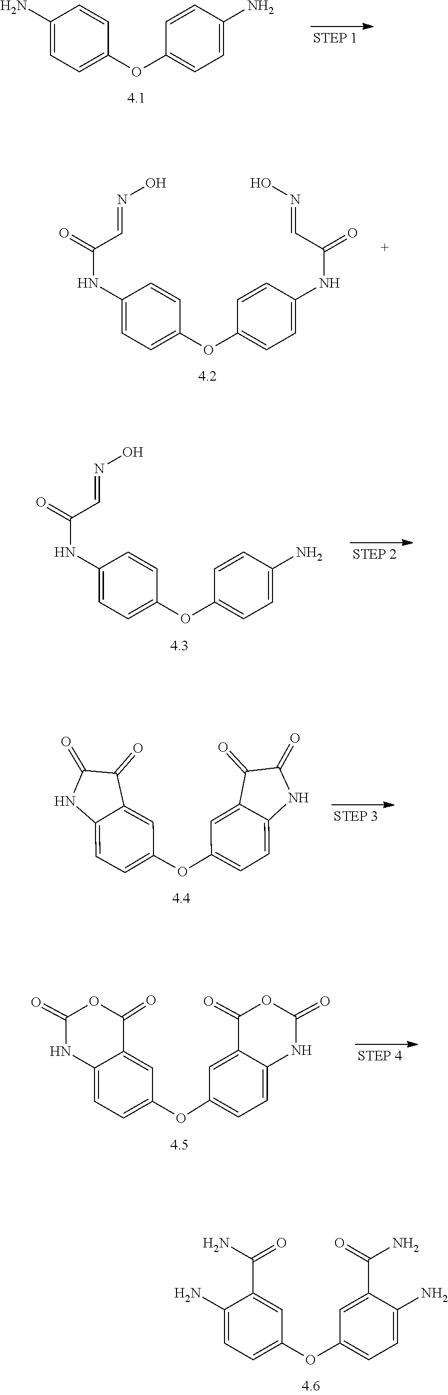 [SMILES: Nc1ccc(Oc2ccc(N)cc2)cc1 ; O=C(/C=N/O)Nc1ccc(Oc2ccc(NC(=O)/C=N/O)cc2)cc1 ; Nc1ccc(Oc2ccc(NC(=O)/C=N/O)cc2)cc1 ; O=C1Nc2ccc(Oc3ccc4c(c3)C(=O)C(=O)N4)cc2C1=O ; O=c1[nH]c2ccc(Oc3ccc4[nH]c(=O)oc(=O)c4c3)cc2c(=O)o1 ; NC(=O)c1cc(Oc2ccc(N)c(C(N)=O)c2)ccc1N]

Step 1 Preparation of (2E,2′E)-N,N′-(Oxybis(4,1-phenylene))bis(2-(hydroxyimino)acetamide) (4.2)

A 2 L 3-necked flask, equipped with reflux condenser, thermometer and nitrogen inlet was charged with a solution of 2,2,2-trichloroethane-1,1-diol (104 g, 4.2 Eq, 629 mmol) in water (525 mL). A solution of sodium sulfate (149 g, 7.0 Eq, 1.05 mol) in water (525 mL) and 4,4′-oxydianiline (30.0 g, 1 Eq, 150 mmol) were added. The reaction mixture was heated to 75° C. Hydroxylamine hydrochloride (52.1 g, 5.0 Eq, 749 mmol) was added as a solid in one portion. Almost immediately a new solid was formed. Heating was continued overnight at 75° C. The reaction mixture was allowed to cool to room temperature. The solids were isolated by suction filtration and washed with water. According to HPLC (MeOH) almost exclusively the desired compound had been formed at Rt=0.66 with M−1=341. The brown solid was stirred with acetonitrile (200 mL) for 10 minutes, filtered and dried under reduced pressure at 70° C. Yield: 30.8 g, 60%.

Step 2 Preparation of 5,5′-Oxybis(indoline-2,3-dione) (4.4)

A 250 mL flask was charged with concentrated sulfuric acid (129 g, 70.1 mL, 45 Eq, 1.31 mol) and was heated to 55° C. Crude (2E,2′E)-N,N′-(oxybis(4,1-phenylene))bis(2-(hydroxyimino)acetamide) (10.0 g, 1 Eq, 29.2 mmol) was added portion wise. The mixture was heated at 90° C. for 1.5 hours and then cooled to room temperature. The dark reaction mixture was poured on ice (300 mL). A brown mixture was formed which was filtered and washed with water. The isolated solids were dried under reduced pressure. No yield was determined. HPLC (DMSO) showed product at 0.62 min with M−1=307. The crude material was used as such for the next step.

Step 3 Preparation of 6,6′-Oxybis(2H-benzo[d][1,3]oxazine-2,4(1H)-dione) (4.5)

mCPBA (19.8 g, 70% WI, 3.5 Eq, 80.4 mmol) was added to a stirred mixture of 5,5′-oxybis(indoline-2,3-dione) (7.08 g, 1 Eq, 23.0 mmol) and acetic acid (100 mL). HPLC showed the formation of the desired product at Rt=0.71 min with M−1=339.

After stirring overnight at room temperature, the reaction mixture was poured into water (50 mL), the crude dark solids were dried by co-evaporation with acetonitrile and taken as such to the next step. Yield: 6.00 g.

Step 4 Preparation of 5,5′-Oxybis(2-aminobenzamide) (4.6)

At 0° C., ammonia (12.0 g, 13 mL, 25% wt, 10 Eq, 176 mmol) was added to a stirred solution of crude 6,6′-oxybis(2H-benzo[d][1,3]oxazine-2,4(1H)-dione) (6.00 g, 1 Eq, 17.6 mmol) in DMF (50 mL). After 40 min the reaction mixture was concentrated under reduced pressure. The dark residue had been standing over the weekend at room temperature. The crude material was purified by automated column chromatography.

### EXAMPLE 5—GENERAL PROCEDURE FOR PREPARATION OF PREFORMS

PET resin is dried prior to use using Con-Air (Trade Mark) dryers for at least four hours at 160° C.

Prior to injection moulding, acetaldehyde scavenger as a dispersion, mixture or liquid is added to hot dry PET pellets and tumble mixed to ensure good dispersion of the scavenger.

Bottle preforms can be produced using an injection moulding machine fitted with an appropriate preform tool.

### EXAMPLE 6—GENERAL PROCEDURE FOR DETERMINING ACETALDEHYDE CONTENT OF PREFORM SAMPLES

The acetaldehyde content of samples is determined on preform samples that have been cryo-ground to less than 1 mm. The level of acetaldehyde is determined using a ThermoFisher Scientific Trace 1310 gas chromatograph with a Triplus 500 headspace autosampler and FID detector. Acetaldehyde reductions are calculated on the basis of percentage reduction seen in the acetaldehyde levels of a preform with additives, compared to that with no additives.

### EXAMPLE 7—PROCEDURE FOR MEASURING OPTICAL PROPERTIES

Plaques made in a manner similar to that described in Example 5 and relevant controls were made and optical properties (i.e. L*, a* and b*) were assessed using a Minolta CM-3700d spectrophotometer in transmission mode fitted with a D65/10° light source.

### EXAMPLE 8—PROCEDURE FOR DETERMINING MIGRATION OF ACETALDEHYDE SCAVENGER FROM PET

Bottles blown from preforms incorporating selected acetaldehyde scavengers along with relevant controls were filled with water and placed in an oven at 60° C. for predetermined times. At various times, the water was sampled using HPLC to determine the level (if any) of migration of acetaldehyde scavengers into the water.

### EXAMPLES 9 TO 22—ASSESSMENT OF ACETALDEHYDE (AA) SCAVENGING ABILITY AND OPTICAL PROPERTIES OF SELECTED MATERIALS

Using the general procedure described in Examples 6 and 7, a range of compounds were assessed and results are provided below. Example C1 material is commercially available anthranilamide, Example C2 material is the dimeric compound referred to in the introduction and Example 3 is a preferred compound of type described in US20180244897 A control comprising C93 PET without any additive is also referenced in each table. In the tables, NA means “not applicable”.

| | Aldehyde | | | | | |
|---|---|---|---|---|---|---|
| | scavenger | | | | | |
| | of | Addition | AA | | | |
| Example | Example | level | reduction | | | |
| No | No | (ppm) | (%) | L*(D65) | a*(D65) | b*(D65) |
| 9 | Control | NA | NA | 86.44 | −0.45 | 1.99 |
| 10 | 1 | 300 | 73.11 | 85.57 | −2.44 | 9.12 |
| 11 | 1 | 400 | 80.00 | 85.50 | −2.61 | 10.11 |
| 12 | 1 | 500 | 86.36 | 85.51 | −2.75 | 10.34 |
| 13 | Control | NA | NA | 86.51 | −0.32 | 1.32 |
| 14 | 2 | 500 | 66.61 | 85.45 | −2.71 | 9.49 |
| 15 | Control | NA | NA | 86.51 | −0.32 | 1.32 |
| 16 | 3 | 500 | 64.97 | 85.55 | −2.56 | 8.47 |
| 17 | Control | NA | NA | 86.11 | −0.44 | 1.82 |
| 18 | C2 | 550 | 76.77 | 85.49 | −3.65 | 12.78 |
| 19 | Control | NA | NA | 86.57 | −0.46 | 1.92 |
| 20 | C1 | 500 | 78.11 | 85.86 | −2.25 | 8.06 |
| 21 | Control | NA | NA | 86.57 | −0.46 | 1.92 |
| 22 | C3 | 550 | 73.15 | 85.42 | −3.88 | 13.6 |

### EXAMPLE 23—COMPARISON OF MIGRATION OF SELECTED ACETALDEHYDE SCAVENGERS FROM PREFORMS

Overall, the results show the compounds of Examples 1 to 3 provide high levels of AA reduction, whilst exhibiting good optical properties, in particular surprisingly advantageous a* and b* which are closer to the control in comparison to other AA scavengers, especially scavengers of the type described in US20180244897. In addition, advantageously, the compounds of Examples 1 to 3 exhibit low levels of migration, particularly in comparison to anthranilamide (Example C1).

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of decreasing aldehyde content in a polymeric material, the method comprising the step of contacting the polymeric material with a compound (Z) which includes a moiety of formula: 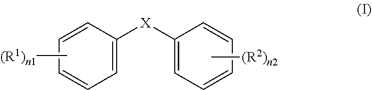
wherein each R¹ and R² independently represents a substituent, n1 is 0 to 4 and n2 is 0 to 4;
wherein X represents a moiety which includes an atom bonded directly to the two benzene rings, wherein said atom is selected from the group comprising C, N, P, O and S atoms;
wherein the left hand benzene ring (herein referred to as the “LHBR”) in the moiety of formula (I) includes a moiety 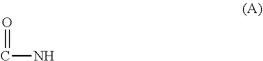
and a moiety
NH (B)
wherein the carbon atom of moiety (A) and the nitrogen atom of moiety (B) are separated by at least one and not more than two atoms;
wherein the right hand benzene ring (herein referred to as the “RHBR”) in the moiety of formula (I) includes a moiety 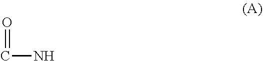
and a moiety
NH (B)
wherein the carbon atom of moiety (A) and the nitrogen atom of moiety (B) are separated by at least one and not more than two atoms.

2. A method according to claim 1, wherein, in said LHBR, the carbon atom of moiety (A) and the nitrogen atom of moiety (B) are separated by at least one and not more than two carbon atoms; wherein the or both of said carbon atoms which separate moieties (A) and (B) is unsaturated; wherein the carbon atom of moiety (A) and the nitrogen atom of moiety (B) are directly bonded to said LHBR; and moiety (B) is bonded to a carbon atom of the LHBR which is ortho to the carbon atom to which the moiety (A) is bonded; and/or
in said RHBR, the carbon atom of moiety (A) and the nitrogen atom of moiety (B) are separated by at least one and not more than two carbon atoms; wherein the or both of said carbon atoms which separate moieties (A) and (B) is unsaturated; wherein the carbon atom of moiety (A) and the nitrogen atom of moiety (B) are directly bonded to said RHBR; and moiety (B) is bonded to a carbon atom of the RHBR which is ortho to the carbon atom to which the moiety (A) is bonded.

3. A method according to claim 1, wherein said LHBR is part of a moiety: 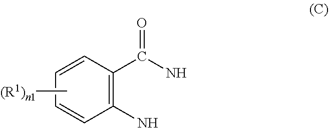
wherein R¹ represents a substituent and n1 is 0 to 4; and/or
said RHBR is a part of a moiety: 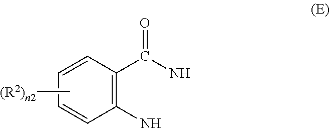
wherein R² represents a substituent and n2 is 0 to 4.

4. A method according to claim 3, wherein, in structure (C), the amide moiety is bonded meta or para to the carbon atom of the benzene ring of moiety (C) to which moiety X is bonded; and/or in structure (E), the amide moiety is bonded meta or para to the carbon atom of the benzene ring of moiety (E) to which moiety X is bonded.

5. A method according to claim 1, wherein n1 is 0, n2 is 0, moiety (B) is NH₂ in said LHBR and moiety (B) is NH₂ in said RHBR.

6. (canceled)

7. A method according to claim 1, wherein said LHBR and said RHBR are substituted with the same atoms or groups, wherein said LHBR and said RHBR are each substituted with a primary amine moiety and said LHBR and said RHBR are each substituted with a primary amide moiety.

8. A method according to claim 1, wherein said RHBR includes only one primary amide group and only one primary amine group and n1 is 0; and said LHBR includes only one primary amide group and only one primary amine group and n2 is 0.

9. A method according to claim 1, wherein said compound (Z) is not a polymer and does not include any polymeric moiety.

10. A method according to claim 1, wherein X represents a moiety which includes a carbon atom bonded directly to the LHR and to the RHBR.

11. A method according to claim 1, wherein moiety X comprises a carbon atom of a carbonyl moiety or of a moiety CR³R⁴ bonded directly to the LHBR and the RHBR, wherein R³ and R⁴ independently represent a hydrogen atom, or an optionally-substituted cycloalkyl, phenyl or naphthyl group.

12. A method according to claim 1, wherein moiety X includes only carbon and hydrogen atoms and no other type of atoms.

13. A method according to claim 1, wherein moiety X comprises a carbon atom of a moiety CR³R⁴ bonded directly to the LHBR and the RHBR, wherein R³ represents a hydrogen atom and R⁴ is selected from the group comprising a hydrogen atom and an unsubstituted phenyl or naphthyl group.

14. (canceled)

15. A method according to claim 1, wherein said moiety of formula (I) has the structure: 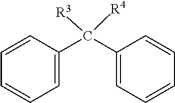
wherein the RHBR includes one primary amide group and one primary amine group, wherein the carbon atom of the amide group and the nitrogen atom of the amine group are separated by two atoms;
wherein the LHBR includes one primary amide group and one primary amine group, wherein the carbon atom of the amide group and the nitrogen atom of the amine group are separated by two atoms;
wherein R³ represents a hydrogen atom;
wherein R⁴ represents a hydrogen atom, an unsubstituted phenyl group or an unsubstituted napththyl group.

16. A method according to claim 1, wherein said compound (Z) is of formula 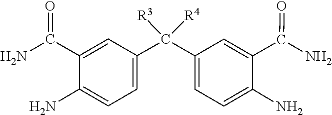
wherein R³ represents a hydrogen atom; and
wherein R⁴ represents a hydrogen atom, an unsubstituted phenyl group or an unsubstituted napththyl group.

17. A method according to claim 1, wherein said polymeric material contacted in the method is poly(ethylene terephthalate); and the total ppm, based on the weight of said polymeric material, of compound (Z) contacted with said polymeric material is at least 100 ppm; and/or the total ppm is less than 2000 ppm.

18. (canceled)

19. (canceled)

20. A method according to claim 1, wherein said polymeric material is a part of and/or defines a shaped article selected from a preform, a container, a bottle, a cup, a tray and a thermoformed sheet;
wherein the method includes a step of making said article from a polymeric material, the method comprising:
(a) selecting a compound (Z);
(b) contacting the polymeric material with said compound (Z); and
(c) forming said polymeric material into said shaped article

21. A method according to claim 1, wherein said polymeric material and/or said article includes one or more colourants, wherein, optionally, after contact of said polymeric material with compound (Z), said polymeric material includes 1-1000 ppm of a colourant.

22. A method according to claim 1, wherein said polymeric material and/or said article includes one or more reheat additives, wherein, optionally, after contact of said polymeric material with compound (Z), said polymeric material includes 1-1000 ppm of said reheat additives.

23. A polymeric material having a reduced level of aldehyde said polymeric material incorporating a compound (Z) according to claim 1, or a product of a reaction between compound (Z) and aldehyde.

24. (canceled)

25. A formulation comprising a compound (Z) according to claim 1 in combination with a carrier, wherein, optionally, said formulation includes 50-90 wt % of a carrier, 10-50 wt % of said compound (Z) and one or both of the following:
0.5 to 10 wt % of one or more colourants;
0.5 to 10 wt % of one or more reheat additives.

26. (canceled)

27. (canceled)

28. (canceled)
